(19) United States
(12) Patent Application Publication
(10) Pub. No.: US 2004/0095766 A1
(43) Pub. Date: May 20, 2004

(54) Structure of table lamp

(76) Inventor: Teng-Chiung Chan, Changhua (TW)

Correspondence Address: RABIN & BERDO, P.C., Suite 500, 1101 14th Street, N.W., Washington, DC, 20005, US

(21) Appl. No.: 10/294,812

(22) Filed: Nov. 15, 2002

(51) Int. Cl. F21S 8/08

(52) U.S. Cl. 362/285; 362/410

(57) ABSTRACT

A structure of table lamp applied in table lamps to provide electric power for lighting the bulb. Teflon wires extend from the circuit device under the base surface, into supporting tubes for connection with conduction heads, so forming the first section of circuit. Electric wires, which are installed in the soft slide rails in the left and the right of an extension tube that extends between the two supporting tubes, extend to the top of the extension tube to pin joint with a bulb under the lampshade, so forming the second section of circuit. With up-and-down movements of the extension tube, the electric wires contact conduction heads to form a galvanic circle. Therefore, inconvenience and complication of structure design are effectively reduced, and simplified structure and convenience of assembly and production are reached to improve the total productivity.

### DESCRIPTION OF THE INVENTION

The present invention provides a structure of table lamp, which will not be affected by circuit layout. An extension tube extends into the long slide way between the two supporting tubes, and extends out from the long slotted hole throughout the top surface of the integrated inner and outer casing body. And moves up and down along the soft railway by using the long slotted hole as axle hole, the pair of supporting tubes as slide way, so as to adjust the lighting angle of the bulb under the lampshade, and provide user with convenience.

Generally, the structure of common lamps sold in the market is composed of a base, a supporting pole that is set on the base and enables users to make angular adjustment, and a bulb under a lampshade that is installed on the top of the supporting pole. When adjusting rotation angle of the supporting pole, the lampshade turns simultaneously. The pin joint location of lampshade with supporting pole can also turn to provide the best angle required by various look angles for convenience of usage.

However, electric power needed for lighting a table lamp is usually supplied by configuring positive and negative power cords. That is to extend positive and negative power cords from the base through the supporting pole for connection with the bulb under the lampshade, so as to provide electric power for the bulb to use. Such a method makes it necessary to put aside space for installing positive and negative power cords while designing the whole structure of table lamp, increasing inconvenience and complexity of structure design, unable to have the convenience of simplification. It also brings inconvenience to assembly and production, as well as difficulty of improving the whole productivity. In addition, wires are not covered at pin joint locations between lampshade and supporting tube, between base and supporting pole. Therefore, the lamp can not be perfectly beautiful.

Additionally, although a method of directly installing positive and negative power cords outside the whole lamp can be employed to improve the aforesaid inconveniences; it still has the shortcomings of being inaesthetic and reducing the total value of table lamp. And because positive and negative power cords are directly exposed, they are likely to be damaged easily, resulting in safety problems.

At the same time, affected by positive and negative power cords, the supporting pole only can make angular adjustments, but can't be extended or shortened. Because once it is extended or shortened, positive and negative cords inside the supporting pole will be prolonged or contracted simultaneously. So, due to repeated pull and extrusion, power cords are likely to be broken or direct short may take place, causing difficulties for supplying electric power normally.

With consideration of the above shortcomings arising from the above structure, the proposer has researched this subject with great concentration based on experiences of many years engaged in lamp manufacturing and feedback results from marketing. Finally, he worked out the lamp structure of the present invention. Here the proposer applies for the new type patent. Thereinto,

The main purpose of the present invention is to provide a structure of table lamp. The extension tube extends into the long slide way between the pair of supporting tubes, and extends out from the long slotted hole through the integrated inner and outer casing body on the ends of the two supporting tubes. And makes up-and-down movements along the soft railway by using the long slotted hole as axle hole and using the pair of supporting tubes as slide way, so as to turn on and turn off the lamp.

Hereinafter, characteristics of the improved structure of the present invention are explained in detail cooperated with drawings for reference of appraisal. Thereinto,

### BRIEF DESCRIPTION OF THE DRAWINGS

FIG. 1-A is a stereo breakdown drawing (A) of the structure of the present invention,

FIG. 1-B is a stereo breakdown drawing (B) of the structure of the present invention,

FIG. 1-C is a stereo breakdown drawing (C) of the structure of the present invention,

FIG. 2-A is an assembly sectional view (A) of local structure of the present invention,

FIG. 2-B is a side sectional view (B) of the aforesaid local structure,

FIG. 3-A is an assembly sectional view (A) of local structure of the present invention,

FIG. 3-B is a side sectional view (B) of the aforesaid local structure,

FIG. 4-A is an implementary example drawing (A) when the structure of the present invention doesn't extend out,

FIG. 4-B is an implementary example drawing (B) when the structure of the present invention extends out.

### DETAILED DESCRIPTION OF THE INVENTION

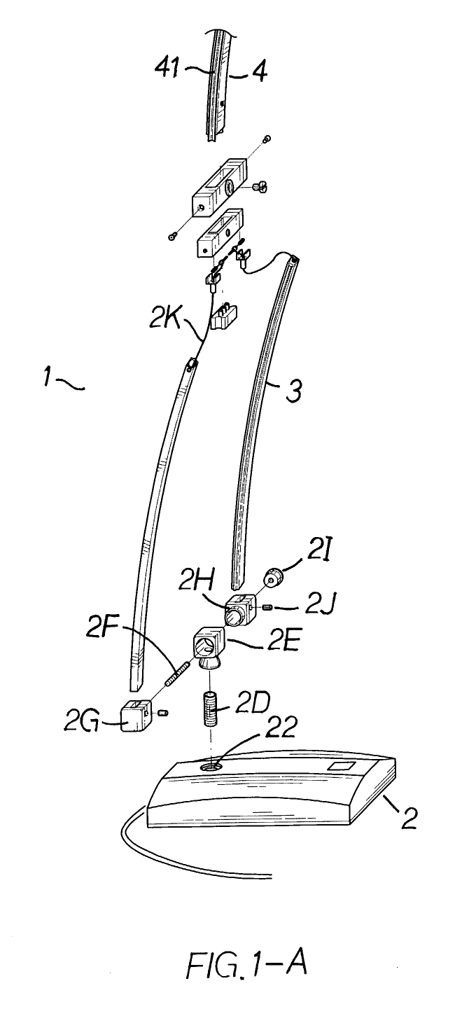

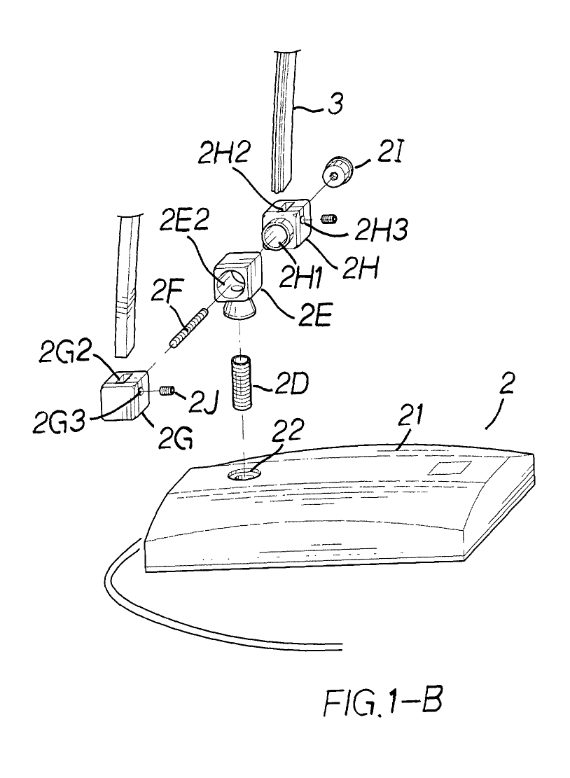

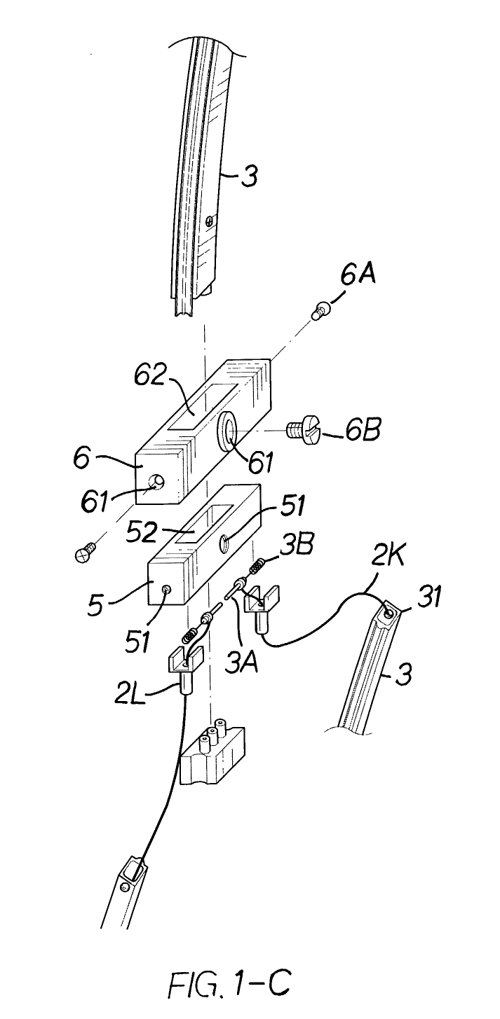

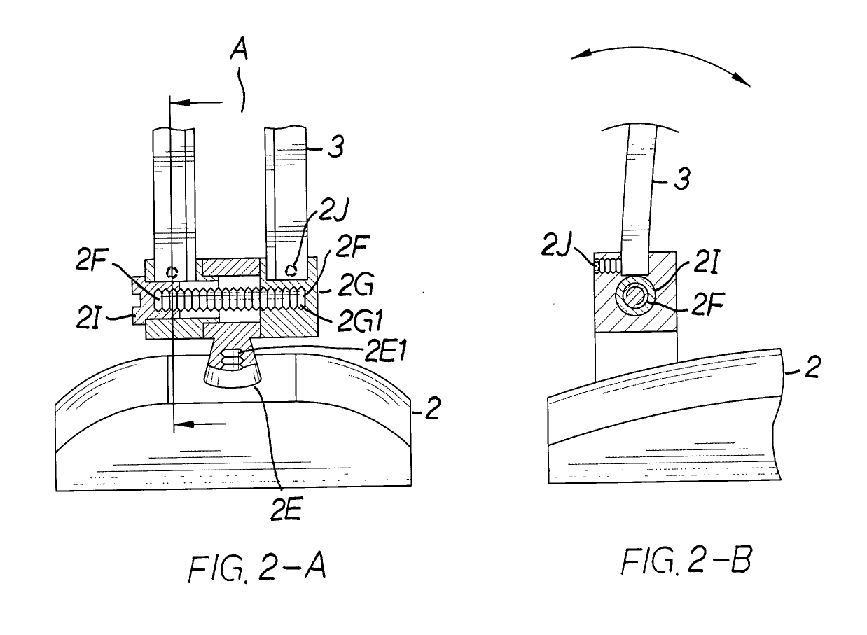

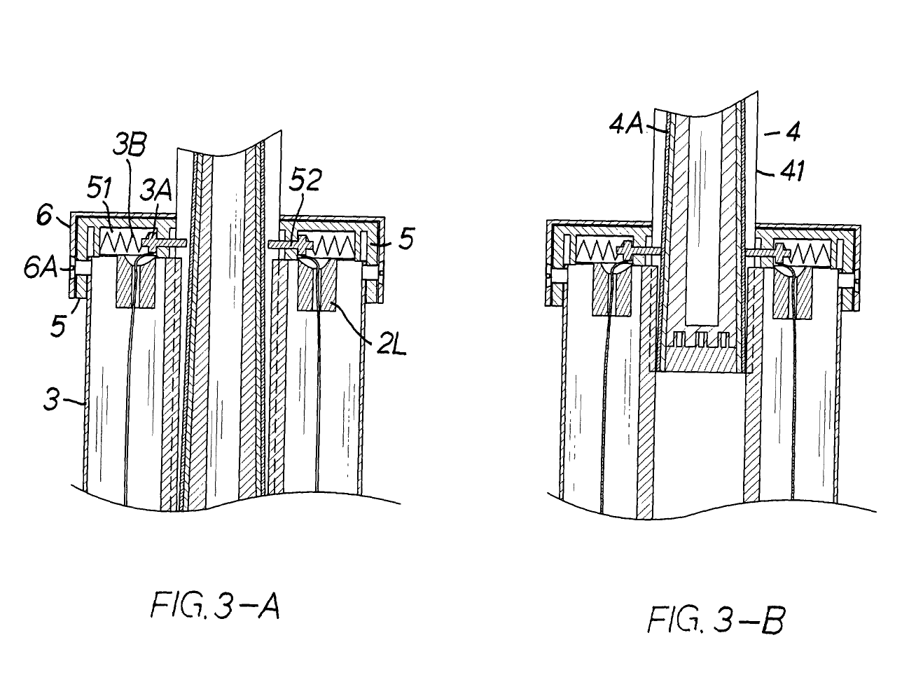

At first, please refer to FIG. 1-A, -B, -C, FIG. 2-A, -B, and FIG. 3-A, -B. As shown in these figures, the structure of table lamp is composed of a base 2, a pair of supporting tubes 3 and an expansion tube 4.

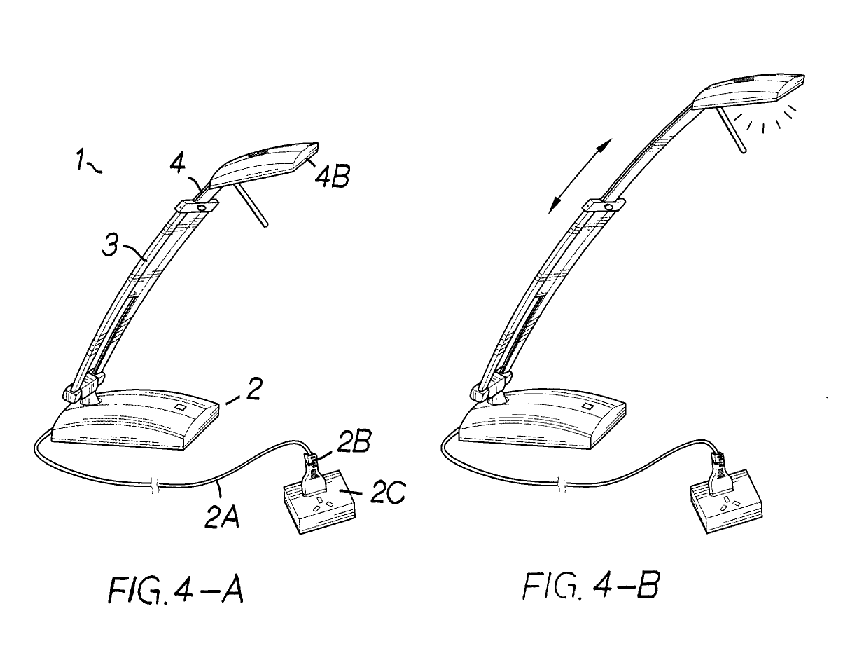

The base 2 extends out an electric wire 2A. Plugged into an outlet 2C, plug 2B of the electric wire 2A is used to conduct electricity to lighten the lamp. As shown in FIG. 4-A and 4-B, there is an axle hole 22 in the middle of the base surface 21. Bolt 2D is inserted into the axle hole 22 and extends out from the base surface 21 in a stand-up way. And the exposed end of bolt 2D is inserted and locked into the screw hole 2E1 on the end of a hold-fast seat 2E, so as to fix the hold-fast seat 2E tightly on the bolt 2D. An axle hole 2E2 is made horizontally throughout the hold-fast seat 2E, and a cross shaft 2F is inserted in the axle hole 2E2 and its two ends extend outside. One end is locked into the screw hole 2G1 in the side face of a transfer seat 2G. While the other end is inserted into the hole 2H1 in the side face of the other transfer seat 2H, and is locked by a screw cap 21. So the two transfer seats, 2G and 2H, are separately locked on the two ends of the cross shaft 2F, and make rotation by using the cross shaft 2F as rotating shaft. There are through jacks 2G2, 2H2 and lockholes 2G3, 2H3 in the top surface and side faces of the two transfer seats 2G, 2H. Jacks 2G2 and 2H2 are used for the pair of supporting tubes 3 of the same diameter to be closely inserted into them in a stand-up way. And screws 2J are locked into lockholes 2G3 and 2H3 to fix the pair of supporting tubes 3 into the jacks 2G2 and 2H3, so as to combine transfer seats 2G, 2H and the supporting tubes 3 into a whole. Therefore, it is able to rotate with the transfer seats 2G, 2H by using the cross shaft 2F as rotating shaft, convenient to adjust oblique angle of the pair of supporting tubes. The Teflon wires 2K, which extend from the circuit device under the base surface 21, are inserted into the hold-fast seat 2E at the end of bolt 2D, and then enter the two supporting tubes through the transfer seat 2G, 2H to connect with conduction heads 3A.

The two supporting tubes 3 are closely inserted in jacks 2G2 and 2H2 on top surfaces 2G and 2H of the pair of transfer seats in a stand-up way, forming a long slide way A for the extension tube 4 to extend into it. The ends 31 of the pair of supporting tubes 3 are covered by the inner and outer casing bodies 5 and 6 in order. The inner casing body 5 is put inside the outer casing body 6 to form a whole and spans between the ends 31 of the supporting tubes 3. Corresponding screw holes 51 and 61 are drilled in the two end faces and one side face of the integrated inner and outer casing body 5 and 6, and screws 6A and 6B are locked into the screw holes 51, 61, and tightly press the pair of supporting tubes 3. So the integrated inner and outer casing body 5, 6 is fixed between the two ends of the pair of supporting tubes 3 as a whole. And grooves 51 are made in the two sides of the inner casing body 5 to set up conduction heads 3A and spring 3B. A small hole 52 is drilled through the inner side of the groove 51, and the conduction head 3A comes through the small hole 52 and extends out of the inner side of the supporting tubes 3. The conduction heads 3A are connected to the Teflon wires 2K installed inside the supporting tubes 3. And before to connect with the conduction head 3A, at first the Teflon wires 2K come through the nonconductor 2L installed inside the notch of the groove 51, so as to ensure safety and prevent electricity leakage. Corresponding slotted holes 52, 62 throughout the integrated inner and outer casing body 5 and 6 are just used for the extension tube 4, which extends into the long slide ways 52, 62 of the pair of supporting tubes 3, to extend out for convenience to make movements. The extension tube 4 is fixed by the screw 6B, which is locked into the screw hole 61 drilled on one side face of the integrated inner and outer casing body 5, 6.

The soft railways 41 are set in the left and the right of the extension tube 4, enabling the extension tube 4 to move up and down along the pair of supporting tubes 3. Installed inside the soft railways 41 and extending to pin joint with the bulb under the lampshade 4B installed on the top of the extension tube 4, the electric wires 4A can move up with the extension tube 4 to contact the conduction heads 3A, so as to form a galvanic circle to conduct electricity for lighting the bulb under the lampshade on the top of the extension tube 4.

Secondly, please refer to FIG. 4-A, -B. The extension tube 4 extends into the long slide way A formed between the pair of supporting tubes 3, and extends out from the long slotted holes 52, 62 through the top surface of the integrated inner and outer casing body 5, 6 installed on the end 31 of the pair of supporting tubes 3. so it is able to make up-and-down movements along the soft railway 41 by using the long slotted hole 52, 62 as axle hole and the pair of supporting tubes 3 as slide way. When the extension tube 4 extends out completely, the electric wires 4A installed on the soft railways in the left and the right of the extension tube 4 will connect to the conduction heads 3A, so forming a galvanic circle to provide electricity for lighting the bulb under the lampshade 4B installed on the top of the extension tube 4.

Contrarily, when the extension tube 4 draws back into the long slide way A of the pair of supporting tubes 3, the electric wires 4A in the soft railways in the left and the right of the extension tube 4 will disconnect with the conduction heads 3A, so forming an open circuit, being unable to provide electricity for lighting the bulb under the lampshade 4B installed on the top of the extension tube 4.

Thus, in the structure of table lamp 1 of the present invention, the electric power for lighting the bulb is supplied in the following way: the Teflon wires 2K installed in the circuit device under the surface 21 of the base 2, extend into the hold-fast seat 2E at the end of bolt 2D through the bolt 2D inserted in the axle hole 22, and then go through transfer seats 2G, 2H in the left and the right of the hold-fast seat 2E into the supporting tubes 3 and connect with the conduction heads 3A, so forming the first section of circuit. And then the electric wires 4A in the soft railways in the left and right of the extension tube 4, which extends in the long slide way A between the two supporting tubes 3, extends to pin joint with the bulb under the lampshade installed on the top of the extension tube 4, so forming the second section of the circuit. The wires connect with or depart from the conduction heads 3A along with the up-and-down movements of the extension tube 4, so as to light or turn off the bulb under the lampshade 4B installed on the top of the extension tube 4. By using this technical method, it is not necessary to set aside space for the first and the second section of circuit when designing the whole structure of table lamp. Therefore, simplified structure and convenience of assembly and production can be reached to improve the total productivity. And parts of circuit at locations of pin joint between lampshade 4B and the pair of supporting tubes 3, and between the base 2 and the supporting tubes 3 are also contained inside the table lamp 1 and not exposed outside. Therefore, the table lamp is perfectly beautiful.

At the same time, the structure of table lamp 1 of the present invention, without being affected by circuit layout, makes the extension tube 4 extend into the long slide way A between the two supporting tubes 3, and extend out from the long slotted hole 52, 62 throughout the top surface of the integrated inner and outer casing body 5, 6 installed on the end 31 of the supporting tubes 3. So it is able to move up and down along the soft railway 41 by using the long slotted hole 52, 62 as axle hole and the pair of supporting tubes 3 as slide way. So it is easy to adjust the lighting angle of the bulb under the lampshade 4B, providing user with great convenience.

From the above description, it can be understood that the present method can avoid inconveniences of common lamps and provide convenience and practicality for users. The present invention meets requirements of practicality and advancement for new type patents. Therefore, please do the favor to approve the present invention to be a legal patent.

1. A structure of table lamp, comprising:
Base: there is an axle hole in the middle of the base. A bolt is inserted into the hole and extends out from the base surface in a stand-up way. The end of bolt that extends out the base surface is inserted and locked tightly into a screw hole on the bottom of holdfast seat to fix the holdfast seat on the bolt. There is a horizontal axle hole in the holdfast seat. A cross shaft is inserted into the hole and its two ends extend out from the axle hole. One end of the shaft is locked into a screw hole on the side of a transfer seat, and the other end is locked into a screw hole on the side of another transfer seat. And screw hole caps are used to lock the two transfer seats, which can turn with the cross shaft, separately on the two ends of the cross shaft. In top surface and side face of each transfer seat there are through jacks and lockholes. Jacks are used for supporting tubes of the same diameter to be closely inserted in a stand-up way. And screws are locked into lockholes to lock supporting tubes. So, transfer seats are united with supporting tubes into a whole, and the cross shaft can be used as a rotating shaft to rotate transfer seats for convenience to adjust oblique angle of the pair of supporting tubes. Teflon wire, equipped in the circuit device under the base surface, is penetrated via the bolt that is inserted in the axle hole into the hold-fast seat at the end of the bolt, and then through transfer seats at the two ends of hold-fast seat penetrated into supporting tubes for connection with conduction heads.
The pair of supporting tubes: they are closely inserted into jacks in top surfaces of transfer seats, forming a long slide way for the extension tube to extend in. Between ends of the pair of supporting tubes inner and outer casing bodies are installed. The inner casing is just put inside the outer cover. In two end faces and one side face of the casing body, corresponding screw holes are drilled, and screw is locked in each screw hole. Screws are locked into screw holes in the two end faces and pin down the pair of supporting tubes, enabling the integrated inner and outer casing body to span between two ends of the pair of supporting tubes as a whole. Grooves are made in the two sides of the inner casing body to set up conduction heads and spring. A small hole is drilled in the side face of each groove for a conduction head to extend out of the inner side of the groove through the hole. The conduction heads are connected to the Teflon wires inside supporting tubes. And before connecting with conduction heads, the Teflon wires go through the nonconductor installed in the notch of the groove, so as to ensure safety and prevent electricity leakage. While a relatively long notch is formed through the top surface of the integrated inner and outer casing body, for the pair of supporting tubes to extend out for convenience to move. The extension tube is fixed up by the screw, which is locked into the screw hole drilled in a side face of the integrated inner and outer casing body.
The extension tube: soft railways are set in the left and the right of the extension tube, so the extension tube can move up and down along the two soft railways. Electric wires are set in soft railways and extend to pin joint with the bulb under the lampshade installed on the top of the extension tube. The electric wires move up to contact the conduction head to form a galvanic circle, so as to electrify the bulb under the lampshade installed on the top of the extension tube for lighting the bulb.
